(19) United States
(12) Patent Application Publication
(10) Pub. No.: US 2007/0120360 A1
(43) Pub. Date: May 31, 2007

(54) Bound component with sticker sheets

(76) Inventors: Edward P. Busam, Mason, OH (US); Diana W. Juratovac, Columbus, OH (US)

Correspondence Address: THOMPSON HINE L.L.P., P.O. BOX 8801, DAYTON, OH, 45401-8801, US

(21) Appl. No.: 11/606,596

(22) Filed: Nov. 30, 2006

Related U.S. Application Data
(60) Provisional application No. 60/740,719, filed on Nov. 30, 2005.

(51) Int. Cl. B42D 15/00

(52) U.S. Cl. 283/81

(57) ABSTRACT

A bound component including a binding mechanism having a first and a second portion extending along a length thereof. The bound component further includes a plurality of pages directly bound only to the first portion of the binding mechanism, and a plurality of sticker sheets directly bound only to the second portion of the binding mechanism.

This application claims priority to U.S. Provisional Application Ser. No. 60/740,719, filed on Nov. 30, 2005, the entire contents of which are hereby incorporated by reference.

The present invention is directed to a bound component, and more particularly, to a bound component having bound pages and sticker sheets.

### BACKGROUND

Bound components, such as notebooks, binders, books, address books, planners, diaries, journals and the like are used to record and store various information. In the use of these bound components, information is typically written on the inside of the bound components (i.e., on the bound pages). However, it may be desired to have a bound component with sticker sheets bound thereto such that a user can remove stickers from the sticker sheets and utilize them on the bound pages. There is also a need for such a bound component wherein the sticker sheets are readily available.

### SUMMARY

In one embodiment, the present invention take the form of a bound component with sticker sheets that are readily available. More particularly, in one embodiment the invention is a bound component including a binding mechanism having a first and a second portion extending along a length thereof. The bound component further includes a plurality of pages directly bound only to the first portion of the binding mechanism, and a plurality of sticker sheets directly bound only to the second portion of the binding mechanism.

In another embodiment the present invention is a bound calendar or planner including a binding mechanism and a plurality of pages bound to the binding mechanism, wherein each page includes calendar indicia printed thereon. The bound calendar or planner further includes a plurality of stickers bound to the binding mechanism. Each sticker includes a pressure sensitive adhesive located thereon such that each sticker is adherable to one of the pages by the pressure sensitive adhesive, and usable in conjunction with the calendar indicia. The stickers and pages are simultaneously viewable.

### BRIEF DESCRIPTION OF THE DRAWINGS

FIG. 1 is a front perspective view of one embodiment of the bound component of the present invention, shown in a closed position;

FIG. 2 is a front perspective view of the bound component of FIG. 1, shown in a partially opened position;

FIG. 3 is a front perspective view of the bound component of FIG. 1, shown in an opened position;

FIG. 4 is a front perspective view of the bound component of FIG. 3, with a sticker sheet exploded and a sticker being peeled/moved; and

FIG. 5 is a front perspective of the bound component of FIG. 2, with various inserts of the cover removed or exploded away.

### DETAILED DESCRIPTION

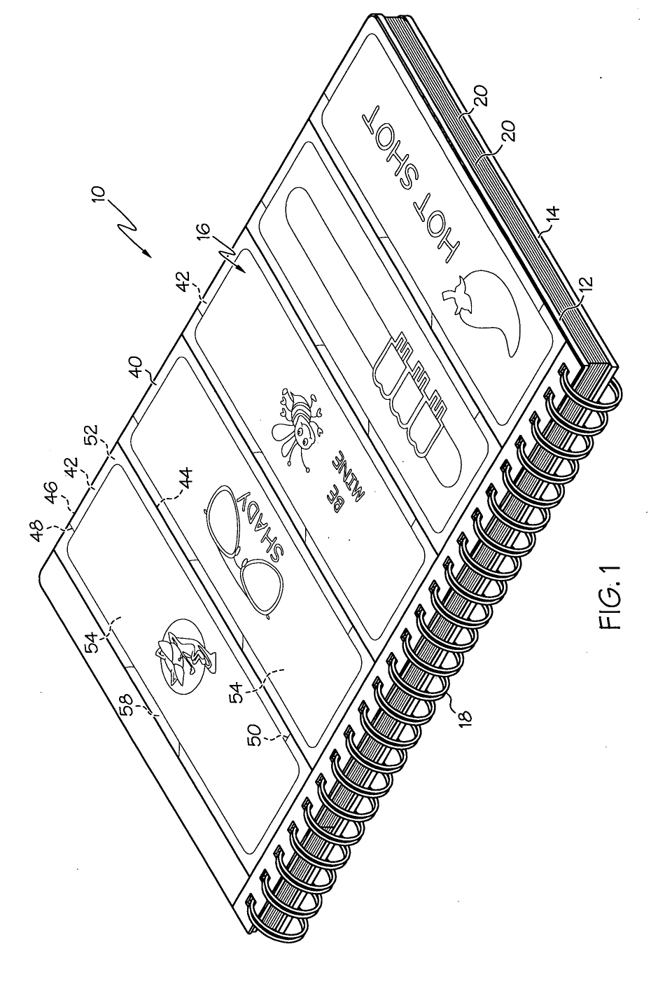

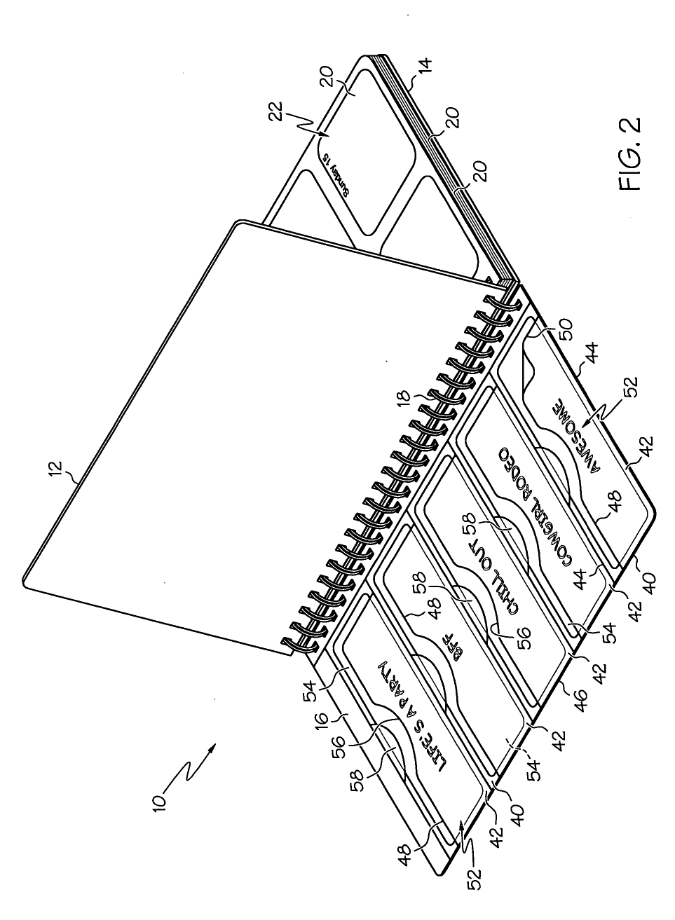

As shown in FIGS. 1 and 2, in one embodiment the bound component 10 of the present invention includes a front cover 12, rear cover 14 and supplemental cover 16 coupled together by a binding mechanism 18. In the illustrated embodiment, the binding mechanism 18 takes the form of a continuous coil wire or spiral wire binding mechanism. However, the binding mechanism 18 may take any of a variety of forms including a three-ring binding mechanism, an adhesive binding mechanism, prongs, clips, etc. The covers 12, 14, 16 can be arranged in various manners, and one or more of the covers 12, 14, 16 may not necessarily be included in the bound component 10.

The binding mechanism 18 binds a plurality of bound pages 20, as well as the covers 12, 14, 16 together. Each bound page 20 may be made of a generally water absorbent material such as cellulose or pulp-based paper to allow a user to write information thereon with a wide variety of writing instruments or media including pens, pencils, markers and the like. In the illustrated embodiment, each of the bound pages 20 include calendar indicia 22 printed thereon and the bound pages 20 are arranged in chronological order. In this case, the bound component 10 may operate as a planner/date book, and the calendar indicia 22 includes a plurality of date boxes or templates printed thereon such that a user can write reminders, appointments, etc. thereon.

The front 12 and rear 14 covers, as well as the supplemental cover 16, may each have a stiffness and/or thickness greater than each of the bound pages 20 to provide protection to the pages 20. For example, the covers 12, 14, 16 can be made of cardboard, paperboard, plastic, a combination of these materials, or the like. The illustrated bound component 10 is configurable such that the pages 20 are positioned between the covers 12, 14 to protect the pages 20.

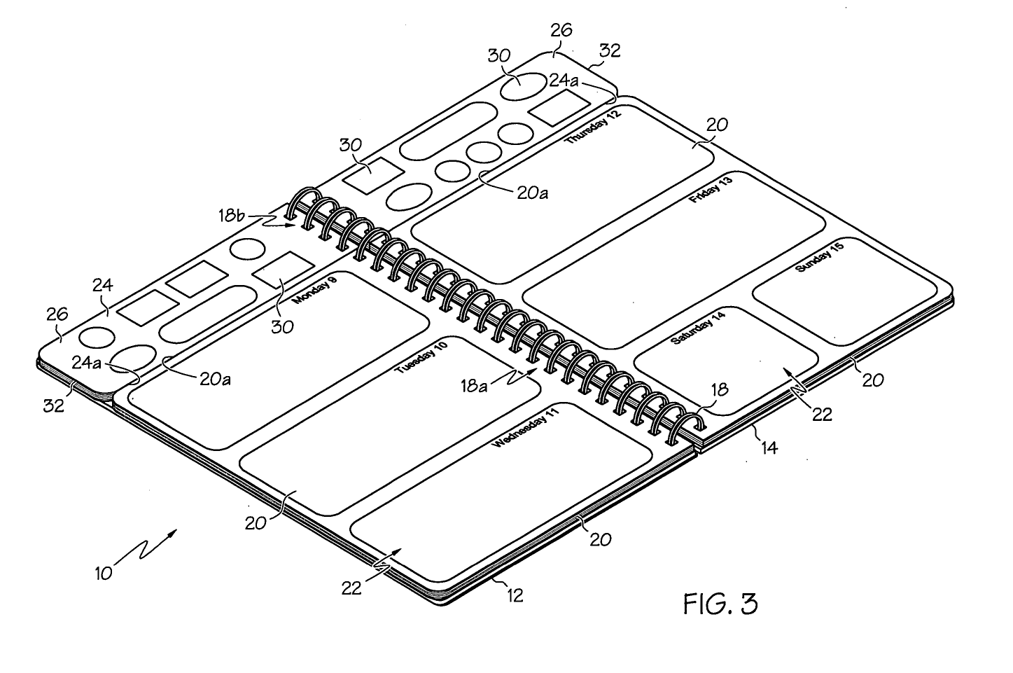

As best shown in FIG. 3, each of the bound pages 20 has a height (i.e., extending generally parallel to the binding mechanism 18) that is less than the height of the covers 12, 14, 16 and binding mechanism 18. Thus, the pages 20 are directly bound only to a lower portion 18a of the binding mechanism 18. A plurality of sticker sheets 24 are directly bound only to the upper portion 18b of the binding mechanism 18 such that the combined height of the sticker sheets 24 and bound pages 20 is approximately equal to the height of the binding mechanism 18 and/or covers 12, 14, 16. In other words, the combined heights of the pages 20 and sticker sheets 24 is about equal to the entire height/length of the binding mechanism 18, or the height of the covers 12, 14, 16.

Each of the pages 20 and the sticker sheets 24 are generally rectangular in top view in the illustrated embodiment. The pages 20 and sticker sheets 24 are also “nested” in the illustrated embodiment such that they are located immediately adjacent to each other to maximize the usable space in the bound component 10. Thus, for example, each page 20 may include an outer edge 20a that is parallel with and located immediately adjacent to an adjacent outer edge 24a of one of the sticker sheets 24. The pages 20 and sticker sheets 24, when located adjacent to each other as shown in the figures, form a generally rectangular shape that generally matches the shape of the covers 12, 14, 16.

Each sticker sheet 24 and each page 20 may include a pair of longitudinal edges and a pair of lateral edges that are shorter than the associated longitudinal edges. In the illustrated embodiment each page 20 is coupled to the binding mechanism 18 along a longitudinal edge and each sticker sheet 24 is coupled to the binding mechanism 18 along a lateral edge. In this arrangement, since each sticker sheet 24 and page 20 has the same width (i.e., in a direction perpendicular to the binding mechanism 18), each page 20 has a larger surface area than the sticker sheets 24. Thus, the pages 20 provide a surface area for writing reminders which can take up a relatively large amount of space, whereas the sticker sheets 24 may only dispense stickers and can be smaller. For example, each page 20 may have a surface area that is at least about twice as large as the surface area of each sticker sheet 24.

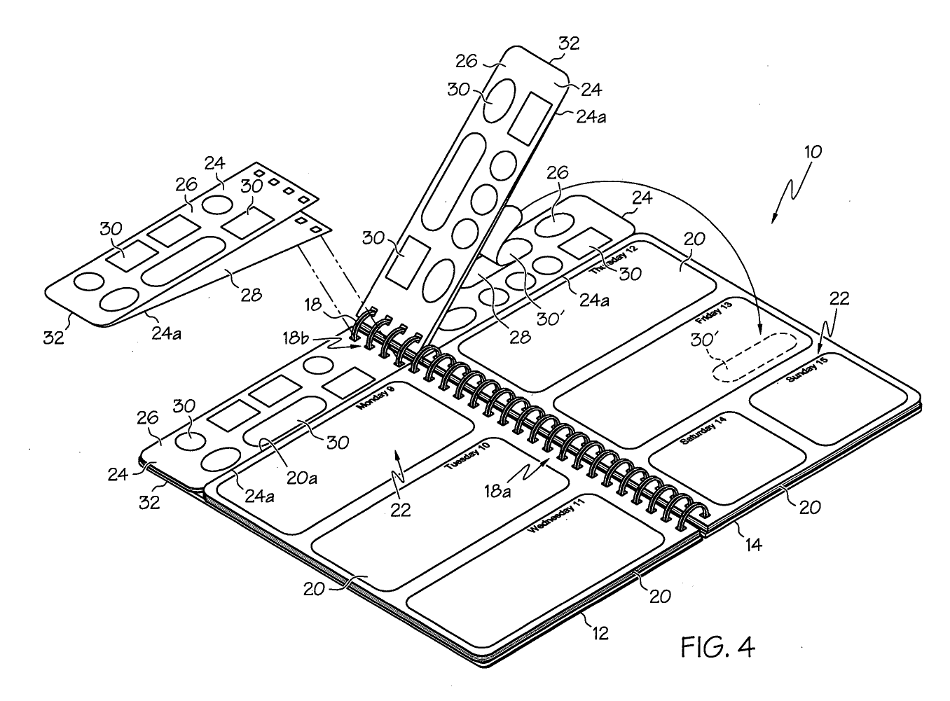

Each sticker sheet 24 may include an adhesive backed sheet 26 coupled to an underlying release liner 28 (see FIG. 4). Each adhesive backed sheet 26 may be die-cut to form a plurality of removable stickers 30 therein. Each sticker 30 may be pre-printed with any of a variety of indicia (not shown), such as text, colors, designs, symbols or the like thereon. For example, the stickers 30 may include decorative or whimsical designs, or reminders (such as “study,” “test,” “quiz,” “doctor,” “orthodontist,” “dentist,” “after school,” “assembly,” “birthday,” special event or sports reminders, and the like). Each sticker sheet 24 may have the same stickers 30 carried thereon, or the various sticker sheets 24 may have differing stickers 30 located thereon.

The stickers 30 are removable from the associated sticker sheet 24 (see sticker 30′ of FIG. 4, which is in the process of being removed) and adhered to the bound pages 20. The stickers 30 may be adhered on a particular date entry of a page 20 to serve as a reminder or to otherwise cooperate with the printed calendar 22. Thus the stickers 30 may operate as reminders of upcoming events, appointments and the like, or may simply operate as decorative items. If desired the stickers 30 can be used on other components besides the bound pages 20 (i.e., on the covers 12, 14, 16 on other bound components 10 or on handouts, notes, etc.).

As noted above the stickers 30 may have a pressure sensitive adhesive on one side thereof to adhere the stickers 30 to the bound pages 20 or other components. The adhesive may be a relatively weak adhesive such that once the stickers 30 are adhered to a bound page 20 or other component, the sticker 30 can be removed without causing any damage or tearing of the stickers 30 and/or bound pages 20 or other underlying component. In this case the stickers 30 may be able to be reused and/or repositioned. Alternately, the adhesive may be relatively strong such that the stickers 30 cannot be removed from the bound pages 20 without causing any damage or tearing of the stickers 30 and/or bound pages 20 or other underlying component. In this case the stickers 30 may be securely positionable on the bound pages 20 and avoid accidentally removal or repositioning.

Each sticker sheet 24 may include stickers 30 on only one side thereof, or may include stickers 30 on both sides thereof. In the embodiment shown in FIG. 4, a single two-ply sheet (i.e., with an adhesive sheet ply 26 and release liner ply 28), with stickers 30 on an outer surface thereof, is folded in half about a laterally-extending central fold line 32 (to form a four-ply sheet 24). The inner edges of the folded sticker sheet 24 has openings formed therein, or other structure to cooperate with the binding mechanism 18, such that the folded sticker sheet 24 can be bound to the binding mechanism 18. In this arrangement a folded, double-sided sticker sheet 24 is provided. However, if desired, each sticker sheet 24 may have stickers 30 on only one side thereof, and the sticker sheets 24 may not be folded. Further alternately, each sticker sheet 24 may be a three-ply sticker sheet (not shown). In this case, the sticker sheet 24 includes a center release liner ply 28 with a pressure-sensitive adhesive backed sheet ply 26 (and associated die-cut stickers 30) located on either side thereof. In this three ply arrangement stickers 30 are provided on both sides of the sticker sheets 24.

In the illustrated configuration the stickers 30/sticker sheets 24 and pages 20 are presented for simultaneous viewing and use. Thus, whenever the bound component 10 is open to its center pages, the user is presented with one or two sticker sheets 24 from which stickers 30 can be selected and utilized. In addition, the sticker sheets 24 can be individually accessed and flipped about the binding mechanism 18 (i.e., independently of the sheets 20) until the user finds the desired sticker sheet 24. For example, if a particular sticker 30 is desired, or all stickers of a displayed sticker sheet 24 are removed, a user can simply leaf through the sticker sheets 24 to find the desired sticker 30 while the pages 20 remain in place. Thus, the arrangement of the present invention provides access to a variety of stickers 30 without having to leaf through the bound pages 20.

The stack of bound pages 20 and stack of sticker sheets 24 may have about the same thickness (i.e., in a direction generally perpendicular to the plane of each bound page 20) such that the covers 12, 14 can lay flat against the pages 20 and sticker sheets 24 when the covers 12, 14 are closed. Although the relative thickness of the various components may vary, in one embodiment each bound page 20 has about one-half the thickness of each sticker page 24 and in this case there may be about twice as many bound pages 20 as there are sticker pages 24 to provide a bound component 10 of uniform thickness.

In the illustrated embodiment, each sticker page 24 is located at a top of the bound component 10/binding mechanism 18. However, various other configurations may be utilized such as, for example, locating the sticker pages 24 at the bottom of the bound component 10/binding mechanism 18, or even in the center of the bound component 10 with pages 20 on either side thereof. In addition, the sticker sheets 24 and the pages 20 may have about the same width (i.e., in a direction extending perpendicular to the binding mechanism 18) as in the illustrated embodiment to maximize usable space. However, if desired, the sticker sheets 24 and/or bound pages 20 may have differing widths, including widths significantly less than the width of the covers 12, 14, 16.

As can be best seen in FIGS. 1, 2 and 5, in one embodiment the bound component 10 may include the supplemental cover, generally designated 16, bound to the binding mechanism 18. In the illustrated embodiment the supplemental cover 16 has about the same size and shape as the covers 12, 14, and has about the same shape and size as the combined pages 20/sticker sheets 24. The supplemental cover 16 includes a front panel 40, and a set of retaining panels 42 coupled to an inner surface thereof. In the illustrated embodiment the supplemental cover 16 (that is, the front panel 40 and retaining panels 42) is made of a generally translucent or transparent material. Each retaining panel 42 is generally rectangular, and is coupled to the front panel along two edges thereof 44, 46, thereby leaving two free edges 48, 50. In this manner, each retaining panel 42 defines a pocket 52 between the retaining panel 42 and the front panel 40, wherein each pocket 52 can be accessed along a free edge 48, 50.

If desired each retaining panel 42 may be coupled to the front panel 40 along three edges thereof instead of two edges. In addition, in the illustrated embodiment, although the supplemental cover 16 includes five pockets 52, the number of pockets 52 can be varied as desired.

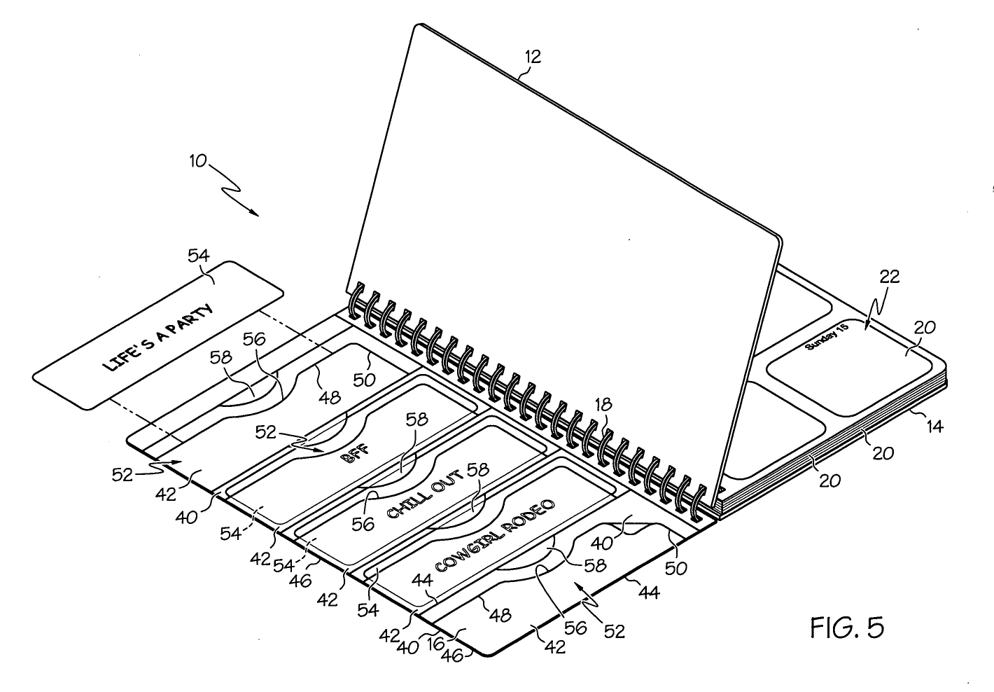

A plurality of inserts 54 may be provided, and packaged and sold with the bound component 10. Each insert 54 may be shaped and sized to be closely received in one of the pockets 52. More particularly, each insert 54 may have a length and width that is at least about 90% of the length and width of each pocket 52 and/or no more than about 110% of the length and width of the pocket 52. In the illustrated embodiment each insert 54 is slightly larger than the pockets 52 and protrude outwardly beyond the pockets 52. FIGS. 1 and 2 illustrate an insert 54 received in each pocket 52; and FIG. 5 illustrates a bottom insert 54 completely removed and a top insert 54 exploded away.

Each insert 54 may have various indicia, such as text, designs, drawings, photographs, patterns, logos, phrases and the like pre-printed thereon. Such indicia may be printed on both sides thereof, or on only a single side thereof. In this manner a user can arrange the inserts 54 in various manners and arrangement in the pockets 52 to customize the cover/appearance of the bound component 10. The pockets 52/inserts 54 may cover the majority of the surface area of the supplemental cover 16, or at least about 90% of the surface area of the supplemental cover 16, so that the inserts 54 provide a decorative outer cover 16. The user can change the arrangement and display of the inserts 54 to change the display of bound components 10 as the user's mood changes over the day, or from day-to-day, and can be used to convey messages to friends or the like.

As best shown in FIGS. 2 and 5, each retaining panel 42 may include a semi-circular notch 56 formed in the upper edge 48 thereof to allow ease of access thereto. A corresponding semi-circular retaining tab 58 may be positioned opposite the associated notch 56 and be coupled to the front panel 40 to retain each insert 54 therebelow and in the associated pocket 52.

If desired, the retaining panels 42 and/or the front panels 10 may be made of generally opaque material to limit the ability to view certain sides of the inserts 54 positioned in the pockets 52. In addition, the pockets 52 may be able to be accessed from either the outer side or the inner side of the supplemental cover 16. For example, in the illustrated embodiment the retaining panels 42 are coupled to an inner surface of the supplemental cover 16 such that the retaining panels 42 are positioned between the front panel 40 and the front cover 12/pages 20 when the bound component 10 is closed. However, if desired this configuration may be reversed such that the retaining panels 42 are coupled to an outer surface of the supplemental cover 16 such that the front panel 40 is positioned between the retaining panels 42 and the front cover 18/pages 20 when the bound component 10 is closed. In this manner, it can be seen that the bound component 10 can take a wide variety of configurations and be used in various manners to provide the advantages described herein.

Having described the invention in detail and by reference to the preferred embodiments, it will be apparent that modifications and variations thereof are possible without departing from the scope of the invention.

What is claimed is:

1. A bound component comprising:
a binding mechanism having a first and a second portion extending along a length thereof;
a plurality of pages directly bound only to said first portion of said binding mechanism; and
a plurality of sticker sheets directly bound only to said second portion of said binding mechanism.

2. The bound component of claim 1 wherein the combined length of said first and second portions are about equal to the entire length of said binding mechanism.

3. The bound component of claim 1 wherein each page and each sticker sheet has a width extending generally perpendicular to said length of said binding mechanism, and wherein the width of each page is about equal to the width of each sticker sheet.

4. The bound component of claim 1 wherein said plurality of pages and said plurality of sticker sheets are each generally rectangular in top view.

5. The bound component of claim 4 wherein each page includes an adjacent outer edge and each sticker sheet has an adjacent outer edge, said adjacent outer edges of each page being parallel with and located immediately adjacent to an adjacent outer edge of one of said sticker sheets.

6. The bound component of claim 4 wherein each sticker sheet and each page includes a pair of longitudinal edges and a pair of lateral edges that are shorter than the associated longitudinal edges, and wherein each page is coupled to the binding mechanism along a longitudinal edge and each sticker sheet is coupled to the binding mechanism along a lateral edge.

7. The bound component of claim 1 wherein said binding mechanism is a coil wire or spiral wire binding mechanism.

8. The bound component of claim 1 wherein said plurality of pages has a combined thickness that is about equal to a combined thickness of said plurality of sticker sheets.

9. The bound component of claim 1 wherein each sticker sheet includes a plurality of stickers with a pressure sensitive adhesive located thereon such that each sticker is removable from said sticker sheet and adherable to one of said pages by said pressure sensitive adhesive.

10. The bound component of claim 9 wherein each sticker sheet has a pair of opposed sides and a plurality of stickers on each opposed side thereof.

11. The bound component of claim 9 wherein each page includes calendar indicia printed thereon, and wherein each sticker includes reminder indicia pre-printed thereon such that each sticker is usable in conjunction with said calendar indicia.

12. The bound component of claim 1 further comprising a front cover and a rear cover, each cover having at least one of a thickness or stiffness greater than one of said pages, wherein said bound component is configurable in a closed position wherein said pages are positioned between said covers and said covers are generally parallel.

13. The bound component of claim 1 further comprising a cover having a plurality of pockets formed thereon, each pocket including a portion of translucent material such that when an insert is inserted into said pocket at least part of said insert is viewable from outside said pocket.

14. The bound component of claim 13 further comprising an insert, wherein said insert is closely receivable in said pocket.

15. The bound component of claim 14 further comprising a plurality of said inserts, wherein each insert is closely receivable in said pocket, and wherein each insert includes pre-printed indicia on both sides thereof.

16. The bound component of claim 1 wherein said bound component is openable such that said pages and said plurality of sticker sheets are simultaneously viewable and accessible.

17. The bound component of claim 1 wherein each of said plurality of pages are independently pivotable about said binding mechanism, and wherein each of said plurality of sticker sheets are independently pivotable about said binding mechanism, and wherein each sticker sheet is pivotable about said binding mechanism independently of each page.

18. The bound component of claim 1 wherein said binding mechanism is a single continuous binding mechanism.

19. A method for using a bound component comprising:
providing a bound component having a binding mechanism with a first and a second portion extending along a length thereof, a plurality of pages directly bound only to said first portion of said binding mechanism, and a plurality of sticker sheets directly bound only to said second portion of said binding mechanism; and
opening said bound component such that at least one of said pages and at least one of said plurality of sticker sheets are simultaneously viewable and accessible.

20. A bound calendar or planner comprising:
a binding mechanism;
a plurality of pages bound to said binding mechanism, wherein each page includes calendar indicia printed thereon; and
a plurality of stickers bound to said binding mechanism, wherein each sticker includes a pressure sensitive adhesive located thereon such that each sticker is adherable to one of said pages by said pressure sensitive adhesive, and usable in conjunction with said calendar indicia, wherein said stickers and pages are simultaneously viewable when said bound calendar or planner is opened.

21. The calendar or planner of claim 20 further comprising a plurality of sticker sheets, each sticker sheet carrying said plurality of sticker thereon.

22. The calendar or planner of claim 20 wherein said binding mechanism has a first portion and a second portion extending along a length thereof, and wherein said plurality of pages are directly bound only to said first portion of said binding mechanism and said plurality of sticker sheets are directly bound only to said second portion of said binding mechanism.

23. The calendar or planner of claim 20 wherein each sticker includes reminder indicia pre-printed thereon.
